(19) United States
(12) Patent Application Publication
(10) Pub. No.: US 2008/0271051 A1
(43) Pub. Date: Oct. 30, 2008

(54) Component-Oriented Application Servers

(76) Inventor: Alexander Auerbach, Berlin (DE)

Correspondence Address: ST. ONGE STEWARD JOHNSTON & REENS, LLC, 986 BEDFORD STREET, STAMFORD, CT, 06905-5619, US

(21) Appl. No.: 12/105,023

(22) Filed: Apr. 17, 2008

Related U.S. Application Data
(63) Continuation of application No. PCT/EP2006/009805, filed on Oct. 11, 2006.

(30) Foreign Application Priority Data
Oct. 17, 2005 (DE) 10 2005 050 303.9

(51) Int. Cl. G06F 9/46

(52) U.S. Cl. 719/315

(57) ABSTRACT

The invention relates to a process for component-oriented application servers and thus to the field of distributed applications. This invention expands component-oriented application servers in such a way that the components of an application implemented on this type of application server can provide graphic surfaces. This expansion is an additional function because network communication capabilities can be used without limitations, precisely as in non-expanded components. This makes it possible to assemble distributed applications entirely out of uniform components, while the advantages of application servers remain entirely available.

### CROSS-REFERENCE TO RELATED APPLICATIONS

The present application is a continuation of pending International patent application PCT/EP2006/009805 filed on Oct. 11, 2006 which designates the United States and claims priority from German patent application 10 2005 050 303.9 filed on Oct. 17, 2005, the content of which is incorporated herein by reference.

### FIELD OF THE INVENTION

The solution of information technology problems increasingly demands the cooperation of mutually networked systems. This requires mastering increasing complexity, which arises not only from increasingly complex challenges but also from the rising technical expenditure for the efficient realization of the distribution and communication of the individual parts of solutions.

To master this complexity, middleware and application servers based on it are among the resources applied. In this manner one simplifies the development of the parts of a solution that affect communication between the parts of applications in a network.

### BACKGROUND OF THE INVENTION

In the context of this invention, code is a description of information technology processes and data. Code refers in particular to data stored in a computer that as the operating instructions for this computer, as well s the structure of an electronic integrated circuit (application-specific electronics). In addition, all services that can definitely be modeled on one of these two forms of codes, or on combined forms of the same, are code.

A particular type of code is source code. This is a code that cannot be executed by direct mechanical means, but instead must be translated into other codes. Code that describes hardware is always source code, because it must first be converted into hardware.

A program in the sense of this invention is the totality of the code required to solve a definite problem or a definite class of problems. This can be for instance a software program that can be executed by a computer or a definite electronic integrated circuit.

A process in the sense of this invention is a program that has just been worked out. It is for instance a software problem that is executed by a computer, or a definite electronic integrated circuit that is supplied with energy and performs its specific task.

An application in the sense of this invention is the totality of the programs required to solve a quantity of logically connected tasks. A single user application such as word processing consists here of just one program. A distributed application consists of one or more programs, but during run time always consists of several processes working together.

A service in the sense of this invention is a particular, clearly defined service that makes a piece of code available to one or more other pieces of code. To fulfill the service usually requires the use of certain resources such as a numerical service and/or storage capacity.

An interface in the sense of this invention refers to a service. Thus it constitutes a binding agreement between the provider and the user of a service. Which parameters are stipulated by the interface for describing a service, depends on the individually applied technology for the definite realization of the service.

Described here is the prior art for application servers and related technologies.

Middleware

The technical basis of application servers is middleware. Middleware allows processors that belong to a distributed application to be available for the run time of reciprocal services. The concept of the service makes possible an abstract and thus simple description of the interactions between parts of applications.

A service is described by one or more interfaces, that is, a defined number of operations. This description normally allows no inference concerning the definite implementation of the service. Thus implementations can be exchanged without modification of other parts of the application that use the particular service. The condition for this is that the modified implementation performs a service with the same interface in the simplest case the interface of a service consists of just one operation.

The code required for providing and using services over a network is either produced with middleware by tools from a description of the service or provided as a standardized partial solution. A middleware is produced either by the tools and language for describing services or by the code of the standardized partial solution. Both the code of the standardized partial solution and the code produced by a tool from an abstract description are designated hereafter as middleware code.

Technically middleware here produces a multiplexer over a simple, bidirectional communication channel as a network provides it between two or more systems. For this purpose middleware code communicates between the application-specific code and the network.

Middleware code is thus necessary both for the program that provides a service, which program is called a service server, and for the program that uses a service and is called a service client. Because this distribution of roles of the program refers to a definite service, a program can be related to a service service server and to another service service client.

The use of a service with middleware occurs over a network, so that the service server and service client can be executed by various systems. The communication between them occurs in run time by the reciprocal addressing of data packets. The middleware code of the service client automatically provides information on the used service and the operation to the data packet that is to be transmitted over the network, in addition to the parameters of the operation.

The middleware code of the service server uses this information in order likewise to execute automatically the code of the operation of the designated service with the transmitted parameters. If this application-specific code provides a result, then it is automatically sent back by the middleware code of the service sender to the service client. There the middleware code of the service client turns over the result to the application-specific code that uses the service.

The application-specific code, which implements the service, must be registered with the middleware code of the service server so that it can be executed. If the service server is software, then it can occur for instance with callback functions, which serve as entry point into the application-specific software code. On the other hand, if dealing with hardware, then the middleware code can provide signal lines, for instance, or busses to which application-specific integrated circuits can be connected.

Services can be produced by middleware in various ways, but in every case must be able to be identified clearly by a service client. With simple services, which provide only one operation, an identification key suffices. If the interface of a service consists of several operations, then the particular operation must also be capable of being clearly identified.

The method or data format with which services and operations are identified by a service client define the particular middleware. Simple middleware, such as remote procedure call (RPC), thus allows a program to provide a series of operations that can be called up individually in run time.

High performance middleware, such as CORBA (common object request broker architecture) or DCOM (distributed component object model), for instance, allows a program to simultaneously provide various services that each are described by its own interface.

With middleware, no distinction is made between the various programs involved in a distributed application. Thus a program can at the same time offer a service and use another, and is therefore both a service server and a service client. With major problems, however, various demands are often made on the various parts of a distributed application. This results in a specialization of the various programs to server and client programs, called servers and clients for short.

Clients here have the predominant task of integrating with the user. Servers, on the other hand, primarily provide services that clients use. Thus a client process is typically used by a single user, while a server process simultaneously makes services available to several client processes.

Application Servers

Application servers provide a layer of abstraction above middleware that is specialized in the development of server programs (see FIG. 3). This increases the scalability of the server program because the close connection of middleware code and application-specific code is increased. With middleware the middleware code and its configuration, which is taken from the application-specific code, predominantly determine the scalability of a server program. Scalability thus designates the number of client processes (3.1) that can simultaneously use the services (3.6) of a server process (3.5). A high scalability means that a great number of simultaneous client processes is supported by the particular server process.

Application servers produce the separation of middleware code and application-specific code by providing each a run time environment (3.3) that can be configured by the user, typically a system administrator, and that contains the middleware code and thus provides usable services over a network. This run time environment can be adapted to the respective run time demands through its configurability. The run time environment also includes infrastructure services, which support the use and supply of services. This can include a name service, for instance.

The application-specific code (3.4), that is, the implementation of the service or services, is supplied to the run time environment in a defined format and is loaded and executed by the environment. Application servers therefore require that the application-specific code must be present as software, contrary to the run time environment itself. The format used here is often standardized so that, because of the use of various run time environments specialized in various use scenarios, the scalability of a server program can be adapted to the particular requirements.

Interactions between application-specific code pieces and run time environment are described by interfaces. Contrary to middleware interfaces, the services described by these interfaces can be used only within the process by which the run time environment and the application-specific code is executed.

Thus it is of decisive importance how the interactions occur between application-specific code and run time environment. For this purpose the application server or the standard, which the application server follows, defines two interfaces (see FIG. 3). The executor interface (3.2) is provided by application-specific code (3.3) and serves the run time environment (3.4) as a specification of the entry points into the application-specific code. The other interface is called a context interface (3.1) and describes the operations and services that the run time environment provides for the application-specific code.

A run time environment can often simultaneously load and execute several application-specific code pieces. Each code piece thus implements one or more services. The application server provides not just the run time environment but also necessary tools to be able to produce these application-specific code pieces in corresponding format.

The decisive advantage of application servers over middleware consists thus in their greater flexibility. This is particularly true for the scalability of the distributed application. While the decision on the definite scaling of an application with middleware must be made during its production, with application servers this decision can also be made in the installation of the solution. In addition, it can also be revised later with relative simplicity, by modifying the configuration of the run time environment or if a different run time environment is used.

Examples of application servers are Web servers, which dynamically produce Web pages. Various standards exist here such advanced server pages (ASP), Java Servlets, or Java server pages (JSP), which each define different requirements for the application-specific code.

A group of application servers that is important for this invention are component-oriented application servers (see FIG. 2). In these servers the application-specific code pieces are components (2.4) that can be combined for form applications. For this purpose the application server provides mechanisms with which the components can offer and use services reciprocally in run time (2.7 or 2.8). This is impossible with non-component-oriented application servers. For example, with Web servers, only Web browsers are foreseen as users of services, but not other code pieces executed by the run time environment.

Because several client processes can simultaneously use the service offered by one component, it is often necessary with condition-dependent components for the component to manage one particular condition for each client process. This makes a conference management necessary that some application servers automatically make available. If this function is not automatically available, then the application-specific code can itself produce this since all operations that affect the condition contain a conference key as additional parameter, which clearly identifies the particular condition.

The automatic conference management with component-oriented application servers is frequently realized by one component providing one component type. In addition the component provides one standardized service with which instances of this component type are produced and whose life cycle can be controlled. Each component instance possesses one condition of its own and can clearly be identified.

Examples of component-oriented application servers with automatic conference management are Enterprise JavaBeans and implementations of the CORBA component model. Web service platforms, on the other hand, are an example of component-oriented application services without an automatic conference management.

Client Programs

Because of the specialization (which accompanies application servers) of the programs participating in a distributed application involved with application servers—a specialization into server programs and client programs—also an exact definition of the tasks of a client program is linked—it interacts primarily with the user. With client programs produced in software, on the other hand, it is above all graphical user interfaces that are used.

For the definition and management of graphical user interfaces, object-oriented GUI libraries (GUI=graphical user interface) are used. Here the program language that is used must not necessarily support the object-oriented program paradigm—the object orientation arises from the specific requirements of graphical user interfaces.

Thus, for instance, for a button, an input field, or a window in the storage facility of the computer there must be a representation. The data stored by this representation contains, for instance, information on the appearance such as the size and position of the corresponding element. In addition such a representation must be able to be clearly identified and referenced in the storage facility in order to be able to modify the stored data and thus the appearance of the element on the screen.

An object is thus either a corresponding construct in a program language, which supports the object-oriented program paradigm, or a clearly identifiable and referenceable storage area, for whose manipulation operations can be defined.

An object-oriented GUI library provides mechanisms to produce GUI objects that define and manage a graphical user interface. This is, for instance, a library of classes.

For a graphical user surface, however, it is essential not just to produce GUI objects, which represent corresponding elements on the screen, but these GUI objects must also be set in relation to one another. Thus typically a GUI object, which represents a button, in order to appear on the screen, must be associated with a GUI object that represents a screen window. In addition it must be placed inside the screen window. The GUI library provides corresponding operations, for instance, as a part of the class definitions.

Examples of GUI libraries are Swing (Java Standard Library) or MFC (Microsoft Foundation Classes).

With the help of a GUI library a client program can define and control the interaction with the user. At the same time the client program uses middleware code in order to use the services provided by the application server.

### SUMMARY OF THE INVENTION

The distinction between server and client programs makes possible the support and flexibilizing of the development process with specialized support resources such as component-oriented application servers. At the same time, however, the various programs of a distributed application can no longer be developed in the same manner as with middleware. While server programs are composed of components, client programs are developed in an object-oriented manner.

From the various technologies there result efficiency losses in development owing to increased learning expenses or a difficult communication between the developers working with various technologies. Because of the advantages of application servers, however, these technologies are for the most part more than compensated. This use of various technologies, however, is problematic when parts of an application are to be reused.

Because a server program with component-oriented application servers is composed of individually developed components, components for the most part can easily be used in several different server programs. This is true both for Enterprise JavaBeans and CORBA components and for Web services.

This flexibility is rarely found with client programs. From the viewpoint of the server program composed of components, the client program is monolith. It cannot simply be dismantled and newly put together. Even if the source code of the client program is present, it is for the most part not possible to precisely extract and reuse those code fragments of the client that belong to a particular impotent of the server. In this way, however, the economically meaningful reusability of components is strongly restricted because for practically every new composition, a new client must be developed.

The invention used to solve the problems rising in the art consists of a technology by which client programs too can be composed of components. The components thus manage the graphical user interface together. This is not possible to date, because the components must exchange object references for this purpose, something that is not possible with middleware interfaces.

The application server is expanded with this invention in such a way that components can exchange object references. This technique is not restricted to GUI objects, but rather can also be used for other object-oriented libraries or any kind of other objects. Since this mechanism is used to exchange references to GUI objects between components, these components together can manage a graphical user interface that can be flexibly adjusted to the particular requirements by the modification of the composition of the client components.

Thus each component is responsible for a particular screen area. In this screen area it can display and manage fundamental surface elements such as buttons or input fields, but can also merge the screen area managed by another component by using a reference to an object that describes this area. Thus a component can, for instance, can display and manage a screen window in which a button is displayed that manages another component.

### BRIEF DESCRIPTION OF THE DRAWINGS

FIG. 1 illustrates an exemplary interaction between client programs and a run time environment of a component-oriented application server.

FIG. 2 illustrates another exemplary interaction between client programs and a run time environment of a component-oriented application server.

FIG. 3 illustrates executor and control interfaces between application-specific code and a run time environment of a component-oriented application server according to an exemplary embodiment of the invention.

FIG. 4 illustrates a run time environment of a component-oriented application server according to an exemplary embodiment of the invention.

FIG. 5 illustrates exemplary code defining the executor and control interfaces.

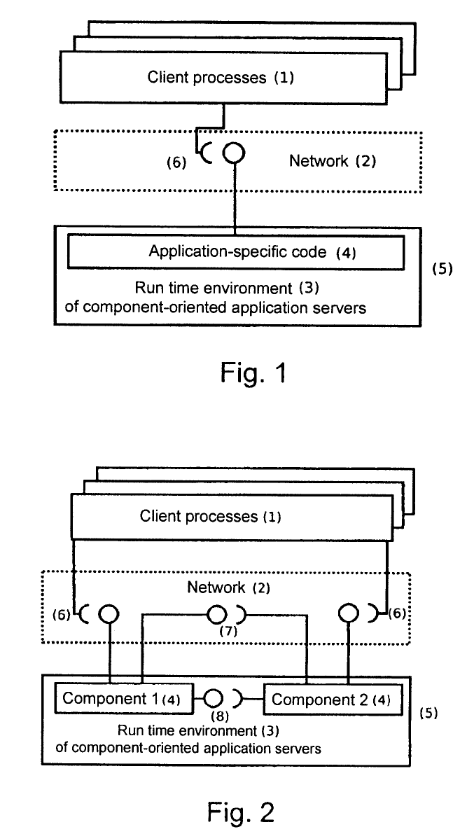

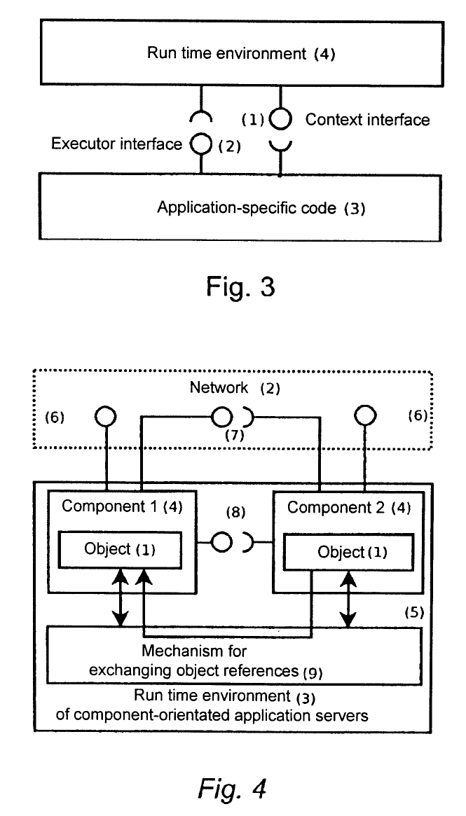

### DETAILED DESCRIPTION OF THE INVENTION

The invention is based on an expansion of the run time environment and its interaction with components (see FIG. 4). Thus the executor interface is expanded by one operation, which returns an object reference. An inventive component, which is designated as a client component, implements this additional operation and in this way makes this object reference available to the run time environment.

If another component requires this object reference in order, for instance, to merge the GUI object referenced by it in its own surface area, then it calls it up from the run time environment. For this purpose the context interface likewise is expanded by one operation, which returns an object reference.

In this operation of the context interface, the component identifies the component whose object reference it requires with a key that is provided as a parameter. If the application server supports component instances, then the reference to the component instance is a meaningful identification key. If the application server provides no automatic conference management, then the explicit conference key or the reference to the component itself is an alternative. All that matters is that the component or component instance is clearly identified by the parameter of the operation.

In this manner a component/component instance can use objects provided by other component/component instances. Here the run time environment ensures that the object references are valid within both participating component implementations.

An inventive configuration thus consists in the fact that the only keys allowed as identification parameters of the additional operation of the context interface are those that designate the component/component instances which are executed by the same run time environment. The run time environment here monitors the transmitting key. For this reason it internally manages a list of valid keys.

An additional inventive configuration is a common storage facility for objects that is used by the participating component/component instances. To make an object available to another component, the component deposits this object in this common storage facility. The object reference transmitted by the mechanism of the run time environment is thus valid in both component implementations and can be used.

An inventive configuration of the run time environment consists in the fact that the additional operation of the context interface is implemented in such a way that it first monitors whether a valid key was transmitted. If this is the case, then it calls the additional operation of the executor interface of the designated component/component instance. If parameters are required for the initialization of the object, both the additional operation of the contact interface and the additional operation of the executor interface are expanded by this parameter. These initialization parameters are advanced from the run time environment to the component. The object reference fed back by the operation of the executor interface is again fed back by the operation of the context interface to the component that is to be called up.

Another inventive configuration of the run time environment is linked to the fact that the objects require no initialization parameters and that the application server supports an automatic conference management. Here the additional operation of the executor interface is called directly after the production of a component instance. The run time environment stores the returned object reference together with the key in an internal data structure. If later the additional operation of the context interface is called up, the object reference that fits the identification key is fed back from the internal data structure.

Another inventive configuration consists in the multiple expansion of the run time environment to make possible the exchange of various types of object references between component/component instances. Thus the context and executor interface is expanded by one operation for every object type.

To simplify the development of client components, another inventive configuration consists in expanding context and executor interface by several operations each for the exchange of a type of object references. An example of this is described in the following case study.

The invention was implemented based on the example of an application server implemented in Java on the basis of the CORBA component model. Swing is used as GUI library in this example.

With the CORBA component model, interfaces are defined in IDL (Interface Definition Language). This is true both for interfaces that describe middleware services and for the executor and context interface. IDL makes it possible to distinguish whether an interface is describing a middleware service or a local service. In both cases an IDL compiler produces from the IDL description an equivalent description in a program language—in this example, in Java. This modeling of IDL onto program languages is defined in CORBA standard for every supported program language.

With CORBA component models, for each application-specific interface of a component a local interface is produced that must be provided by the implementation of the component. The run time environment provides the middleware interface at run time, where every operation uses the operation of the local interface provided by the component implementation. In addition, further configurable actions are executed by the run time environment in order, for instance, to support transactions automatically or to put through a safety model.

To realize the invention, the executor and context interface are expanded. Because IDL generation provides support at interfaces, one interface is defined each time that contains the necessary operations. The actual context or executor interface is additionally derived from the particular interface.

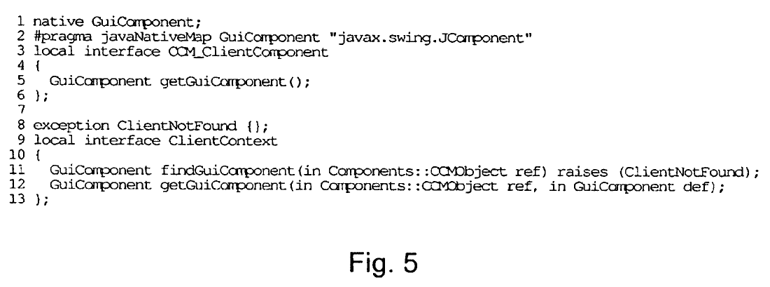

The definition of the two interfaces is shown in FIG. 5. In row 1 a data type, “GUI component,” is defined in IDL. This type is not projected on a Java type like other IDL types corresponding to the standardized imaging rules, as indicated by the key word “native.” In row 2 is a stipulation of which Java-type “GUI component” serves as model: “Javax.swing JComponent.” This Java class is the basic class of all surface elements of the Swing library that can manage an element or an area within a display window.

In lines 3 through 6, the additional basic interface “CCM ClientComponent” of the executor interface is defined. This interface contains the operation “getGuiComponent,” which returns an object reference of the “GuiComponent” type. Because this type of IDL compiler is mapped on “Javax.swing JComponent,” the component implementation for this operation must provide a corresponding object and return a reference. The run time environment always calls this operation directly after a component instance has been produced. The returned object reference is stored together with the component instance in an internal data structure. If the implementation of this operation returns “null,” then no entry is made in the internal data structure.

In rows 8 through 13, the additional basic interface “ClientContext” of the context interface is defined. For this purpose, in row 8 the exception “ClientNotFound” is first defined, which can be returned by an operation if an exception condition arises and the operation cannot fulfill its normal task.

In row 11 the operation “findGuiComponent” is defined. This operation awaits a parameter of the type “Components::CCMObject.” This is the basic type of every CORBA component type, so that every instance of a CORBA component is of this type. This operation is implemented by the run time environment in such a way that it searches in the internal data structure for the entry that belongs to the delivered CORBA component instance. The related object reference is returned. If the CORBA component instance cannot be found in the internal data structure because, for instance, it is executed by a different run time environment or the implementation of the operation “getGUIComponent” of the component instance has returned “null,” then the operation throws the exception “ClientNotFound.”

The second operation of the “ClientContext” interface defined in line 12 is intended only to facilitate the development of transparent code. If a component questions an object reference with the operation “findGuiComponent” of its context interface, then it must conduct an error treatment in the event that an exception is thrown. If the object whose reference is questioned is responsible only for an optional component of the graphical user interface, then, with the operation “getGuiComponent” of the context interface, the error treatment can be dispensed with and an object reference of a placeholder object can be indicated as second parameter. In cases in which the operation “findGuiComponent” throws an exception, then with it “getGuiComponent” provides the object reference delivered as second parameter.

The run time environment of a component-oriented application server shields the components it executes from one another. In this way dysfunctions that are difficult to repair are prevented by a reciprocal influence. Middleware services are frequently available as the sole interaction mechanism.

In a few cases, however, it can be necessary to interrupt this reciprocal shielding for the solution of a problem. The invention therefore provides an efficient mechanism. Because this mechanism, like the other services provided by the run time environment, is used by a component implementation, the advantages of application servers remain intact.

With the invention, however, entirely new fields of application open up. Because objects of a GUI library can be exchanged, a graphic surface can be made up cooperatively of several components. Clients, exactly like servers, can thus be composed of reusable components. Thus function blocks can be made up of components for servers and components for clients, which as a whole can be reused. With the reuse of components with application servers without this expansion, the costly adjustment or new development of the client no longer is required.

The mechanism for exchanging object references, like the run time environment of the application server, can be realized both in software and in hardware. The increase in speed of execution of an application because of a realization of the run time environment in hardware is usable without restriction with the described expansion.

1. A component-oriented application server, wherein components can mutually provide one another with objects or object references.

2. A component-oriented application server as in claim 1, wherein the run time environment makes available to the components a defined mechanism for reciprocal providing of objects or object references.

3. A component-oriented application server as in claim 2, wherein the reciprocal furnishing of objects or object references is produced by operations of the context and/or of the executor interface.

4. A component-oriented application server as in claim 2, wherein in addition the components can reciprocally make available to one another only objects or object references of a certain type.

5. A component-oriented application server as in claim 4, wherein in addition the mechanism for reciprocal furnishing of objects or object references is restricted to objects of a class library or classes derived from it.

6. A component-oriented application server as in claim 4, wherein in addition the mechanism for reciprocal furnishing of objects or object references is restricted to objects of a surface library.

7. A component-oriented application server as in claim 4, wherein in addition the mechanism for reciprocal furnishing of objects or object references according to claim 4 is available in quantity for various object types.

8. A component-oriented application server as in claim 1, wherein in addition the components use a common storage facility for applying objects that can be reciprocally made available.

9. A component-oriented application server as in claim 1, wherein in addition the reciprocal furnishing of objects or object references is restricted to components that are executed by the same run time environment.

10. An application server comprising;
a controller; and
software, executing on the controller, being two or more components;
and wherein the components exchange objects or object references.

11. The application server of claim 10 in which the executing software defines a development environment.

12. The application server of claim 10 in which the executing software defines a production environment.
